(19) United States
(12) Patent Application Publication
(10) Pub. No.: US 2009/0291735 A1
(43) Pub. Date: Nov. 26, 2009

(54) GAMING SYSTEM AND METHOD OF GAMING

(76) Inventors: Steven A. Jasper, Henderson, NV (US); Jacob M. Jasper, Henderson, NV (US)

Correspondence Address: MCANDREWS HELD & MALLOY, LTD, 500 WEST MADISON STREET, SUITE 3400, CHICAGO, IL, 60661, US

(21) Appl. No.: 12/469,021

(22) Filed: May 20, 2009

Related U.S. Application Data
(60) Provisional application No. 61/054,650, filed on May 20, 2008.

(51) Int. Cl. A63F 9/24; A63F 13/00

(52) U.S. Cl. 463/19; 463/30

(57) ABSTRACT

A game controller comprises a display module operable to display a Bingo game card. The Bingo game card has a plurality of symbol spaces which are populated independently of a player with a set of symbols such that at least one symbol free space remains. The at least one symbol free space is locatable in any one of the plurality of symbol spaces. A matching module is also provided which is arranged to match drawn symbols against the symbols provided on the game card. An award module makes an award responsive to determining that a match condition has been met.

### RELATED APPLICATIONS

This application claims priority to U.S. Application No. 61/054,650, having a filing date of May 20, 2008, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a gaming system, game controller and a method of gaming.

It is known to provide a gaming system which comprises a game controller arranged to randomly display several symbols from a predetermined set of symbols and to determine a game outcome such as a game win based on the displayed symbols. Such gaming systems may commonly be implemented as a stepper machine provided with reels with each reel carrying several symbols of the set, or a video machine wherein selected symbols are displayed on virtual reels on a video display. Win outcomes can occur based on symbols appearing in one or more horizontal lines, diagonal lines, or any other predetermined way.

While such gaming systems provide users with enjoyment, the need exists for alternative gaming systems in order to maintain or increase player enjoyment.

### BRIEF SUMMARY OF THE INVENTION

In accordance with a first aspect, the present invention provides a method of gaming comprising:

providing a Bingo game card having a plurality of symbol spaces populated independently of a player with a set of symbols such that at least one symbol free space remains, the at least one symbol free space locatable in any one of the symbol spaces;

matching drawn symbols against the symbols provided on the Bingo game card; and

making an award responsive to determining that a match condition has been met.

In an embodiment at least one of the number and position of the symbol free space(s) is based, at least in part, on a random determination.

In an embodiment the random determination is made utilising at least one of a random number algorithm or pathways selection process.

In an embodiment the method comprises the further step of allowing a player to select the set of symbols provided on the Bingo game card.

In an embodiment the match condition specifies at least one of the number and arrangement of matched symbols on the game card that constitutes an award.

In an embodiment the method comprises the further step of providing a plurality of the Bingo game cards, each game card having a number and positioning of symbol free spaces that is based, at least in part, on a random determination.

In accordance with a second aspect the present invention provides a game controller comprising:

display module operable to display a Bingo game card having a plurality of symbol spaces populated independently of a player with a set of symbols such that at least one symbol free space remains, the at least one symbol free space being locatable in any one of the plurality of symbol spaces;

matching module arranged to match drawn symbols against the symbols provided on the game card; and

award module arranged to make an award responsive to determining that a match condition has been met.

In an embodiment the game controller further comprises a free space selector module which is operable to select at least one of the symbol free space number and position(s) based, at least in part, on a random determination.

In an embodiment the game controller further comprises an input device operable to allow a player to select the set of symbols provided on the game card.

In an embodiment the set of symbols is determined by a symbol selector module of the game controller.

In an embodiment the match condition specifies at least one of the number and arrangement of matched symbols on the game card which constitutes an award.

In an embodiment the set of symbols provided on the game card are selected from the same symbol set as the drawn symbols.

In a third aspect the present invention provides a gaming device, the gaming system comprising: at least one player terminal implementing a display;

and a game controller comprising a:

display module operable to display on each display, a Bingo game card having a plurality of symbol spaces populated independently of a player with a set of symbols such that at least one symbol free space remains, the at least one symbol free space being locatable in any one of the plurality of symbol spaces;

matching module arranged to match drawn symbols against the symbols provided on each game card; and

award module arranged to award a prize to individual gaming terminals responsive to determining that a match condition has been achieved on the corresponding display.

In accordance with a fourth aspect, the present invention provides computer program code which when executed by a processor implements the above methods.

In accordance with a fifth aspect, the present invention provides a computer readable medium providing a computer program in accordance with the fourth aspect.

In accordance with a sixth embodiment a data signal comprising the program code of the fourth aspect.

### BRIEF DESCRIPTION OF SEVERAL VIEWS OF THE DRAWINGS

Features and advantages of the present invention will become apparent from the following description of embodiments thereof, by way of example only, with reference to the accompanying drawings, in which:

FIG. 1 is a schematic block diagram of core components of a gaming system, according to an embodiment of the present invention;

FIG. 2 is a perspective view of a gaming machine arranged to implement the gaming system of FIG. 1, according to an embodiment;

FIG. 3 is a schematic block diagram of operative components of the gaming machine shown in FIG. 2;

FIG. 4 is a schematic block diagram representing the structure of a memory of the gaming machine shown in FIG. 2;

FIG. 5 is a schematic diagram of a networked gaming system;

FIG. 6 is a further schematic block diagram of the gaming system;

FIGS. 7a and 7b are screen shots illustrating example operation of game play; and

FIG. 8 is a flowchart of an embodiment.

### DETAILED DESCRIPTION OF THE INVENTION

In an embodiment a game controller of a gaming device comprises a display module operable to display a Bingo game card having a plurality of symbol spaces populated independently of a player with a set of symbols such that at least one symbol free space remains. The at least one symbol free space is locatable in any one of the plurality of symbol spaces. A matching module is also provided and arranged to match drawn symbols against the symbols provided on the game card. An award module makes an award responsive to determining that a match condition has been met.

### General Construction of Gaming System

The gaming system can take a number of different forms. In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

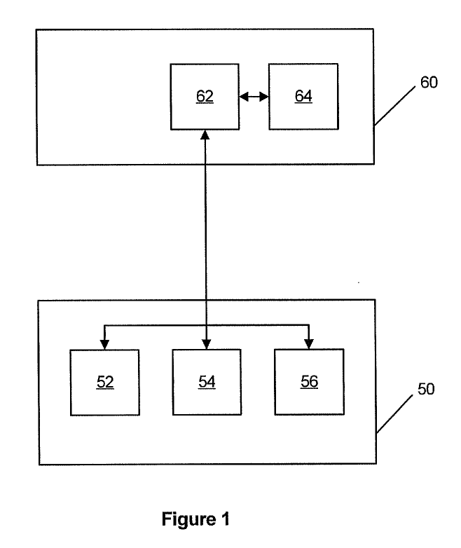

Irrespective of the form, the gaming system comprises several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions and play the game.

Components of the player interface may vary from embodiment to embodiment but will typically include a credit mechanism 52 to enable a player to input credits and receive payouts, one or more displays 54, a game play mechanism 56 that enables a player to input game play instructions (e.g. to place bets), and one or more speakers 58.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

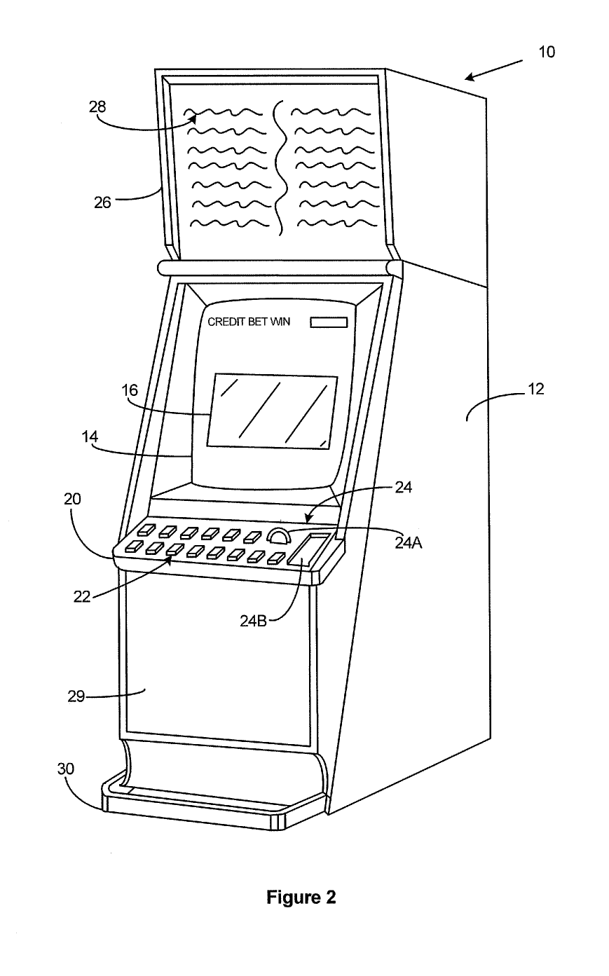

A gaming system in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module (not shown) having a reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

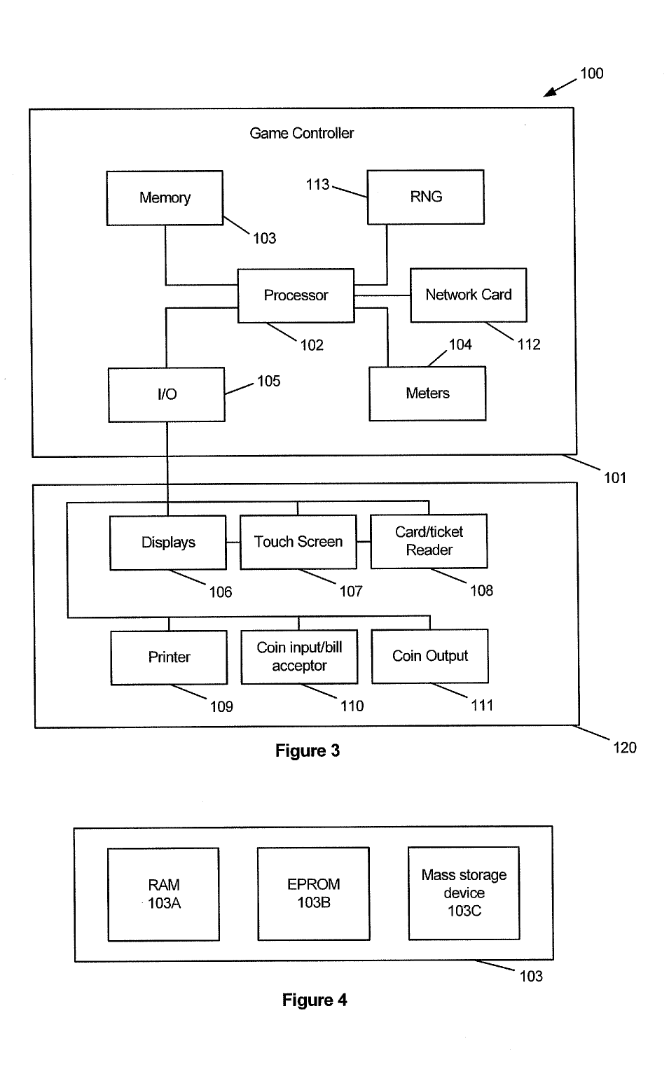

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 comprise one or more displays 106, a touch screen and/or buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

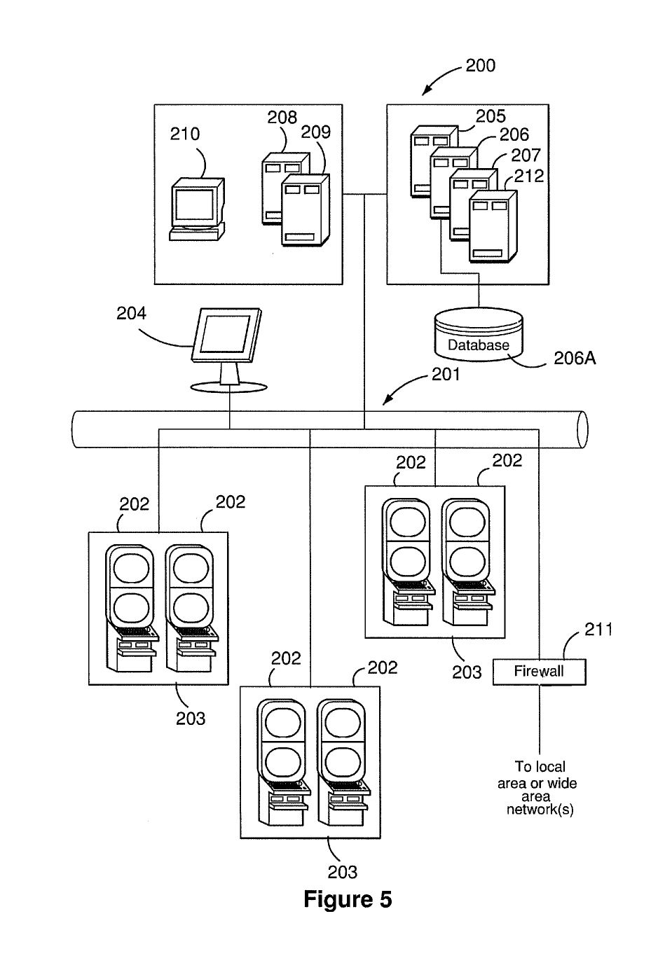

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games as required by the terminals.

Persons skilled in the art will also appreciate that the method of the preferred embodiment could be embodied in program code. The program code could be supplied in a number of ways, for example on a computer readable medium, such as a disc or a memory (for example, that could replace part of memory 103) or as a data signal (for example, by downloading it from a server).

### Further Detail of the Game Controller

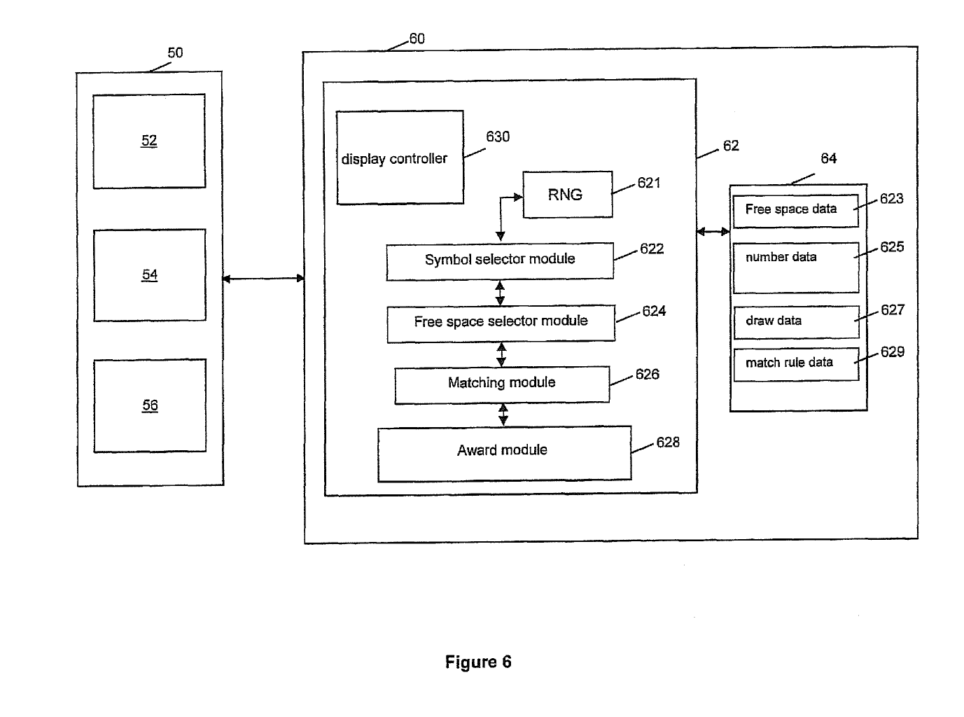

The game controller 60 of an embodiment is shown in more detail in FIG. 6. For simplicity, only those modules needed to carry out embodiments of the invention are illustrated in FIG. 6. Other standard and/or non-standard modules may also be implemented for carrying out operation of normal and feature game play functionality.

The game controller 60 includes a processor 62 which is arranged to control game play and to determine a game outcome. It will be apparent that the processor 62 implements a number of modules, namely a random number generator module 621, symbol selector module 622, free space selector module 624, matching module 626, award module 628 and display module 630, based on program code stored in memory 64.

Persons skilled in the art will appreciate that not all modules need be implemented by processor 62. Other implementations are envisaged. For example, the functional modules of FIG. 6 may be implemented in hardware or separate units, or a combination of hardware and software as separate units. Any practical implementation of these functional units may be employed.

In the embodiment described herein the game implemented by the game controller 60 is a variation of the game of Bingo. As will be understood by persons skilled in the art, a typical game of Bingo involves matching randomly drawn symbols against a set of symbols displayed on a game card and awarding a prize when a designated number or configuration/pattern of matched symbols has been achieved. The game card usually comprises twenty five symbol spaces arranged in a five by five matrix. All of the symbol spaces are populated with symbols (usually numbers), with the exception of the centre square which is considered to be matched. The centre square is commonly referred to as the “free space”.

In contrast to such conventional Bingo card configurations, embodiments provide that one or more symbol free spaces are positioned in any of the symbol spaces (i.e. not only the centre square), as determined by a free space selector module 624 of the game controller 60. The position(s) of the one or more symbol free spaces may be randomly determined utilising, for example, the random number generator 621, a pathways selection process, or some other randomised selection technique.

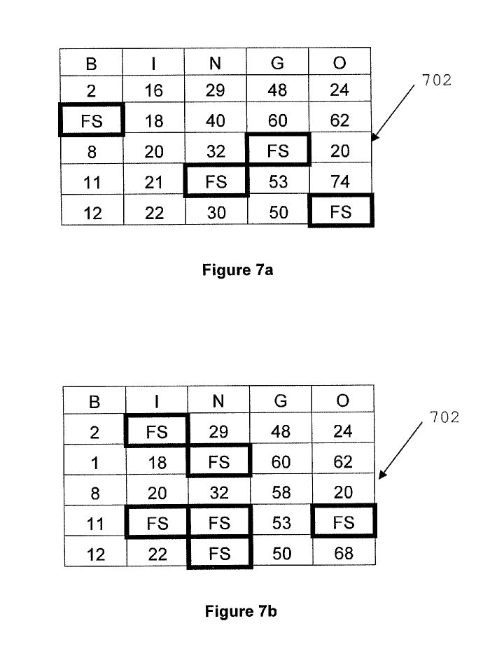

FIGS. 7a and 7b are illustrations of example Bingo game cards that may be displayed by the display module 630, in accordance with an embodiment. The Bingo card 702 comprises a standard five by five matrix randomly populated with both numbers and symbol free spaces “FS”, with no number repeated. It will be understood that the size of the matrix can vary as can the type of displayed/drawn symbols, depending on the actual implementation. It will also be understood that the maximum number and/or position of free spaces may vary. For example, the maximum number may depend on an amount wagered by the player in the game or according to some other game-related factor.

Upon commencement of game play, the free space selector module 624 selects both the number and position of symbol free spaces based, at least in part, on a random determination (e.g. utilising the RNG 621). In an embodiment, the determination may additionally be based on a minimum and maximum number of symbol free spaces available for selection. For example, the number of free spaces available for selection may range from 1 to 6.

According to the FIG. 7a example, four symbol free spaces are selected, while the example shown in FIG. 7b shows that six free symbol spaces have been randomly selected. The symbol selector module 622 subsequently determines a set of numbers for populating the remaining symbol space positions. Again, the numbers may be determined randomly using the RNG 621. Data representative of the symbol free space positions and card number selections is stored in memory 64 as free space position data 623 and number data 625, respectively.

Once all symbol spaces on the game card 702 have been populated, the symbol selector module 622 randomly draws numbers to be matched against the numbers displayed on the game card 702, based on draw data 627 stored in memory 64. This part of the game will hereafter be referred to as the “draw phase”. During the draw phase the matching module 626 is operable to match each drawn number against the numbers displayed on the game card 702 and, if a match is detected, instruct the display module 630 to provide an indication on the relevant symbol space of a match condition. In an alternative embodiment, the player may have the responsibility of marking the symbol space to show a match in much the same manner as a conventional paper based implementation. The player may make the indication using either the touch screen panel or some other input device provided on the gaming machine 10. Such an implementation may increase the level of skill required in so far as players need to find and locate the drawn number on their game card 702 prior to the next number being drawn.

The award module 628 determines whether a prize is to be awarded by determining whether a particular number or arrangement of matched symbols has been achieved during the draw phase. Data specifying the winning arrangements is stored in memory 64 as match rule data 629. For example, the arrangement may be a horizontal, vertical or diagonal line of matched numbers. In an embodiment the arrangement may be that all of the numbers on the game card 702 have been matched, which is commonly referred to as a “cover-all” or “black-out”. It will be understood that any number of different pre-announced patterns/arrangements may constitute winning configurations, dependent only on the desired implementation.

In an embodiment a plurality of the Bingo game cards 702 may be played at the same time (i.e. as part of the one game) either by the same player or by a number of different players. In the multi-player implementation, the controller may be responsible for causing one or more Bingo cards to be displayed on each player terminal. It will be appreciated that the controller may be located independently of the terminals (e.g. incorporated into a jackpot server, as a stand alone network device, or the like), or implemented by one of the actual gaming terminals (e.g. in a client-server type configuration). The numbers played on each game card may be different, as may be the number and positioning of symbol free spaces. Again, players may have the option of “marking” off matched numbers on each game card after a number has been drawn, or alternatively this may be automatically carried out by the matching module 626.

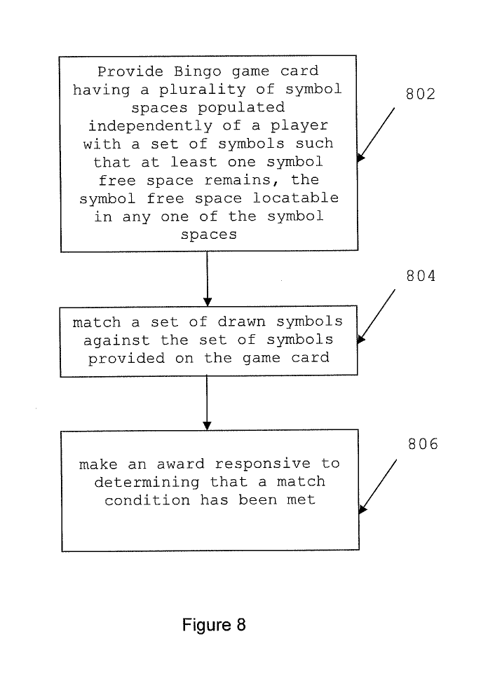

A method 800 in accordance with an embodiment is summarised in FIG. 8. In step 802 a Bingo game card is provided. The game card has a plurality of symbol spaces which are populated, independently of the player, with a set of symbols such that at least one symbol free space remains. In contrast to conventional Bingo game cards, the at least one symbol free space is capable of being located in any one of the symbol spaces and not simply in the centre square. At step 804 a set of drawn symbols is matched against the game card symbols. The final step 806 involves making an award responsive to determining that a match condition has been met.

The aforementioned embodiments provide an alternative type of game play to that provided by traditional Bingo-type games. By randomly selecting the position and optionally the number of free spaces on a game card, a new and exciting variation of a match game may be implemented which may provide players with increased chances of being awarded a prize and thus heightening the sense of excitement experienced by the player.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of gaming comprising:
providing a Bingo game card having a plurality of symbol spaces populated independently of a player with a set of symbols such that at least one symbol free space remains, the at least one symbol free space locatable in any one of the symbol spaces;
matching drawn symbols against the symbols provided on the Bingo game card; and
making an award responsive to determining that a match condition has been met.

2. A method of gaming as claimed in claim 1, wherein at least one of the number and position of the symbol free space(s) is based, at least in part, on a random determination.

3. A method of gaming as claimed in claim 2, wherein the random determination is made utilising at least one of a random number algorithm or pathways selection process.

4. A method of gaming as claimed in claim 1, comprising the further step of allowing a player to select the set of symbols provided on the Bingo game card.

5. A method of gaming as claimed in claim 1, wherein the match condition specifies at least one of the number and arrangement of matched symbols on the game card that constitutes an award.

6. A method of gaming as claimed in claim 1, comprising the further step of providing a plurality of the Bingo game cards, each game card having a number and positioning of symbol free spaces that is based, at least in part, on a random determination.

7. A game controller comprising:
display module operable to display a Bingo game card having a plurality of symbol spaces populated independently of a player with a set of symbols such that at least one symbol free space remains, the at least one symbol free space being locatable in any one of the plurality of symbol spaces;
matching module arranged to match drawn symbols against the symbols provided on the game card; and
award module arranged to make an award responsive to determining that a match condition has been met.

8. A game controller as claimed in claim 7, further comprising a free space selector module which is operable to select at least one of the symbol free space number and position(s) based, at least in part, on a random determination.

9. A game controller as claimed in claim 7, further comprising an input device operable to allow a player to select the set of symbols provided on the game card.

10. A game controller as claimed in claim 7, whereby the set of symbols is determined by a symbol selector module of the game controller.

11. A game controller as claimed in claim 7, wherein the match condition specifies at least one of the number and arrangement of matched symbols on the game card which constitutes an award.

12. A game controller as claimed in claim 7, wherein the set of symbols provided on the game card are selected from the same symbol set as the drawn symbols.

13. A gaming system including:
at least one player terminal implementing a display; and
a game controller comprising a:
display module operable to display on each display, a Bingo game card having a plurality of symbol spaces populated independently of a player with a set of symbols such that at least one symbol free space remains, the at least one symbol free space being locatable in any one of the plurality of symbol spaces;
matching module arranged to match drawn symbols against the symbols provided on each game card; and
award module arranged to award a prize to individual gaming terminals responsive to determining that a match condition has been achieved on the corresponding display.

14. A method as claimed in claim 1, further comprising a computer program code to be executed by a processor.

15. A method as claimed in claim 14, further comprising a computer readable medium including said program code.

16. A method as claimed in claim 14, further comprising transmitting or receiving a data signal including said computer program code.
